(19) United States
(12) Patent Application Publication
(10) Pub. No.: US 2006/0277468 A1
(43) Pub. Date: Dec. 7, 2006

(54) System and method for dynamic, embedded help in software

(75) Inventor: Frederick Sapir, Sanford, NC (US)

Correspondence Address: BINGHAM MCCUTCHEN LLP, 3000 K STREET, NW, BOX IP, WASHINGTON, DC, 20007, US

(73) Assignee: Oracle International Corporation

(21) Appl. No.: 11/142,404

(22) Filed: Jun. 2, 2005

(51) Int. Cl. G06F 9/00

(52) U.S. Cl. 715/708

(57) ABSTRACT

Improved online help is provided, which is easier to use, provides improved effectiveness and content quality, and provides improved user satisfaction. A method for providing help information to a user of software comprises providing a user interface of the software, determining an element or function of the software that the user likely intends to use, identifying help information corresponding to the element or function of the software that the user likely intends to use, and displaying the identified help information to the user.

### BACKGROUND OF THE INVENTION

1. Field of the Invention

The present invention relates to providing an implementation of Support Vector Machines functionality integrated into a relational database management system

2. Description of the Related Art

As software application have become more complex to use, the need for online help and documentation to guide the user of the application has become ever more important. Many applications use a Hypertext Markup Language (HTML) based or similar pop-up system to deliver online help and documentation to the user. While this is a common delivery system, it does have two distinct implementation problems:

First, the help content “pops up” in a new window, as shown in FIG. 5. Not only does this cover (i.e., hide) the element with which the user needed help, but it also creates a disconnect between the application and its help system. To the user, the application and its help system now appear as separate entities.

Second, such a help system requires the user to break their workflow, stop their current action, and explicitly request assistance from the application. Many users are unlikely to request help from an application in such circumstances. In addition, by forcing the user to ask for help, the application implicitly attaches a stigma to the help system, implying that the user is not smart enough to figure things out.

These two problems reduce the overall effectiveness of the online help, regardless of the actual quality of the help content and documentation. This results in lower usability and user satisfaction. A need arises for an improved online help system, which is easier to use, provides improved effectiveness and content quality, and provides improved user satisfaction.

### SUMMARY OF THE INVENTION

The present invention provides improved online help, which is easier to use, provides improved effectiveness and content quality, and provides improved user satisfaction.

A method for providing help information to a user of software comprises providing a user interface of the software, determining an element or function of the software that the user likely intends to use, identifying help information corresponding to the element or function of the software that the user likely intends to use, and displaying the identified help information to the user. The identified help information may be displayed to the user by displaying the help information in a portion of the user interface so that the help information does not obscure any other portion of the user interface. The help information may be displayed in a pane of the user interface. The element or function of the software that the user likely intends to use is determined by identifying a focus of a selection of an element of the user interface by the user, and determining an element or function of the software that the user likely intends to use based on the selection of an element of the user interface by the user. The help information corresponding to the element or function of the software that the user likely intends to use is identified by identifying a identifier corresponding to the likely user intent based on the selected interface element and obtaining the help page using the identified identifier. The identifier is a unique help topic identifier. The help page is obtained using the identified identifier by using the identifier to access a lookup table to identify the help page and obtaining the identified help page.

### BRIEF DESCRIPTION OF THE DRAWINGS

Further features and advantages of the invention can be ascertained from the following detailed description that is provided in connection with the drawings described below:

FIG. 1 is an exemplary software block diagram of a system architecture in which the present invention may be implemented.

FIG. 2 is exemplary block diagram of an MBean that supplies a graphical user interface to a management console.

FIG. 3 is an exemplary flow diagram of a process of supplying a graphical user interface (GUI) to a management console from an MBean.

FIG. 4 is an exemplary block diagram of a computer system in which the present invention may be implemented.

### DETAILED DESCRIPTION OF THE PREFERRED EMBODIMENTS

The present invention provides improved online help, which is easier to use, provides improved effectiveness and content quality, and provides improved user satisfaction. Usability is improved by embedding the help system within the application. This provides the help content at a location on the screen that does not hide the element whit which the user needed help. The help system is also dynamic, which provides access to help content without the user having to break their workflow to request the help content.

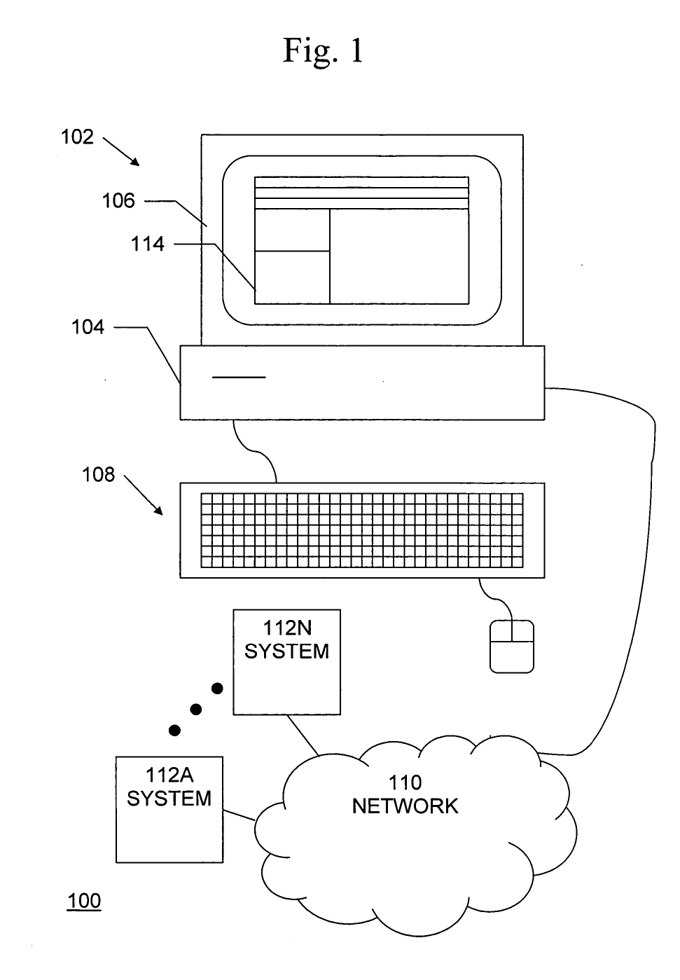

An example of a system 100 in which the present invention may be implemented is shown in FIG. 1. System 100 includes a user computer system 102, which includes a computer 104, a display device 106, and input devices 108. User computer system 102 is typically used to perform processing of data and other computerized tasks for an individual user. Typically user system communicates via a network 110 with one or more other computer systems, such as systems 112A-N.

In order to perform processing of data and other computerized tasks, a user operates software executing on computer system 102. Such software may be an application program or any other type of software that may execute on computer system 102. In order to allow the user to operate the software, the software generates or otherwise causes to be displayed a user interface 114. User interface 114 performs functions that allow the user to operate the software, such as outputting information and status to the user and accepting commands and information from the user.

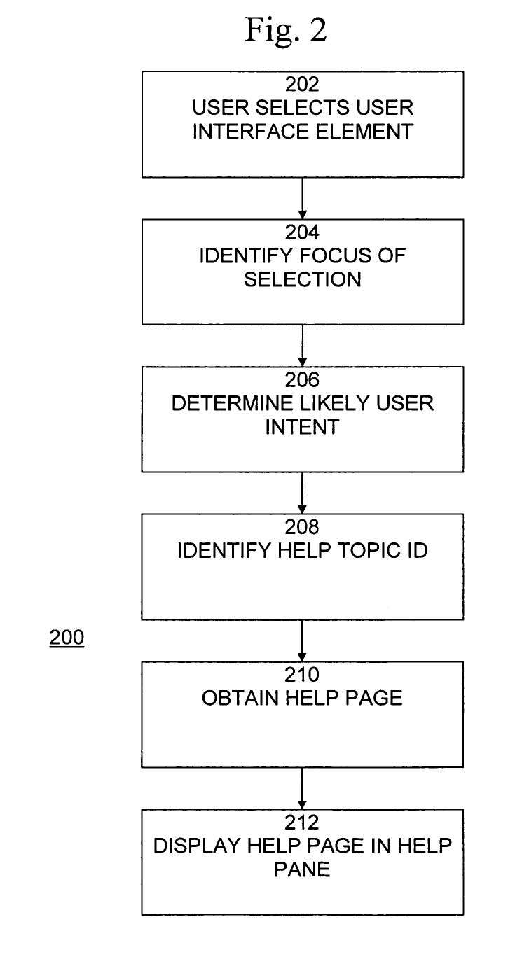

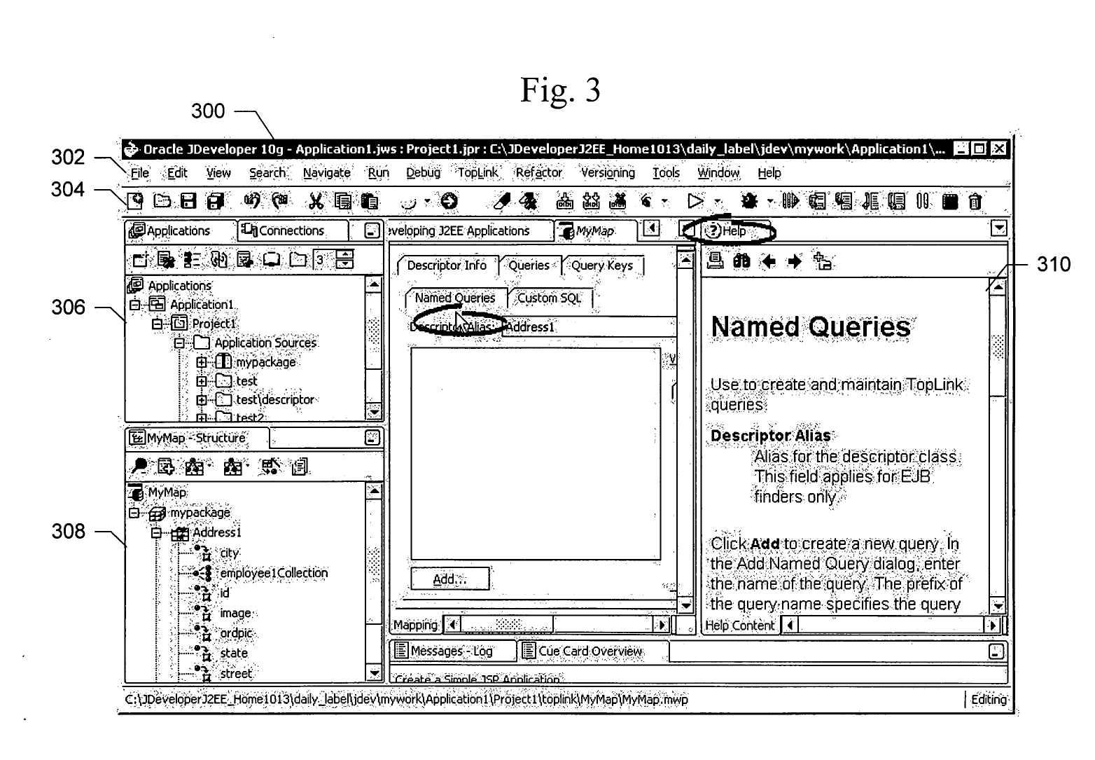

An exemplary flow diagram of a process 200 of providing dynamic, embedded help in software is shown in FIG. 2. It is best viewed in conjunction with FIG. 3, which is an illustration of an exemplary user interface 300 generated by software including dynamic, embedded help. Process 200 starts with step 202, in which the user of the software selects an element of the user interface of the software. This action is not performed by the user in order to obtain help with the element of the user interface, but rather is performed in the normal course of operation of the software. Typically, the user uses a mouse or other pointing device to select the element of the user interface, but the selection may be made using a keyboard, touchscreen, voice recognition, or any technology capable of interaction with software.

For example, user interface 300 includes a plurality of user interface elements, such as menus 302, tool icons 304, and information panes, such as panes 306 and 308. Menus 302 and tool icons 304 are used to select functions and features to be performed by the application with which user interface 300 is associated. Information panes provide the capability to display information to the user and to allow the user to modify the information. User interface 300 also includes help pane 310, which provides the capability to display help information to the user.

In step 204, the focus of the selection is identified. For example, a specific tree node, dialog box, button, etc. that is displayed by the user interface is identified as the particular element that is the focus of the selection. In step 206, the element or function that the user is likely intending to use or attempting to perform is determined based on the user's actions. For example, if the user opens the Print dialog, such as operating the menus 302 or tool icons 304, they are likely attempting to print a page. In step 208, a unique help topic identifier corresponding to the likely user intent is identified based on the selected interface element. For example, the help topic ID for the Print dialog box may be dialog.print.

In step 210, a help page corresponding to the identified help page ID is obtained. For example, a lookup table, such as a .map file, may be accessed to determine which help page corresponds to the help topic ID, and to obtain the help page. An example of such a table lookup is:

<mapID target=“dialog.print”url=“file000001.html”/>

A .map file is an XML file that associates IDs with files. The primary use of the map file is to define topic IDs and associate them with topic files. You can also associate topic IDs (and thereby the topics) with any window types defined in <wintype> elements in the helpset file. These IDs are used in the table of contents files, in index files, and in the API for context-sensitive calls. It is to be noted that the .map file is merely an example of a type of that may be used by the present invention and that the present invention contemplates use with any file type or lookup table type.

In step 212, the application automatically displays the help page that has been obtained in the embedded help pane 302 of user interface 300.

Additionally, the capability may be provided to allow the user to control aspects of the dynamic embedded help system by selecting user preferences. An example of such a user preference selection dialog is shown in FIG. 6.

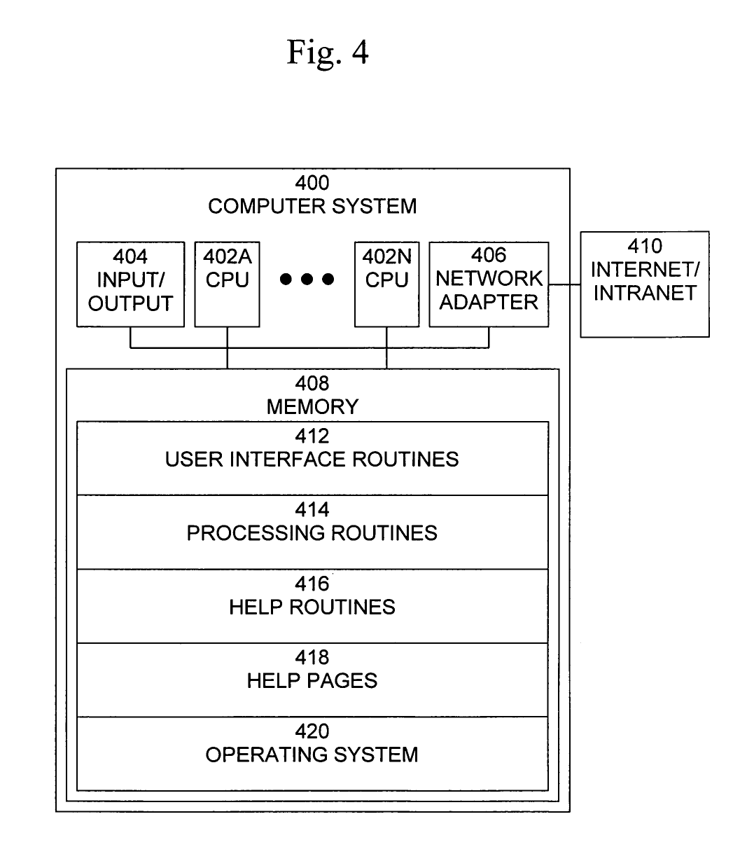

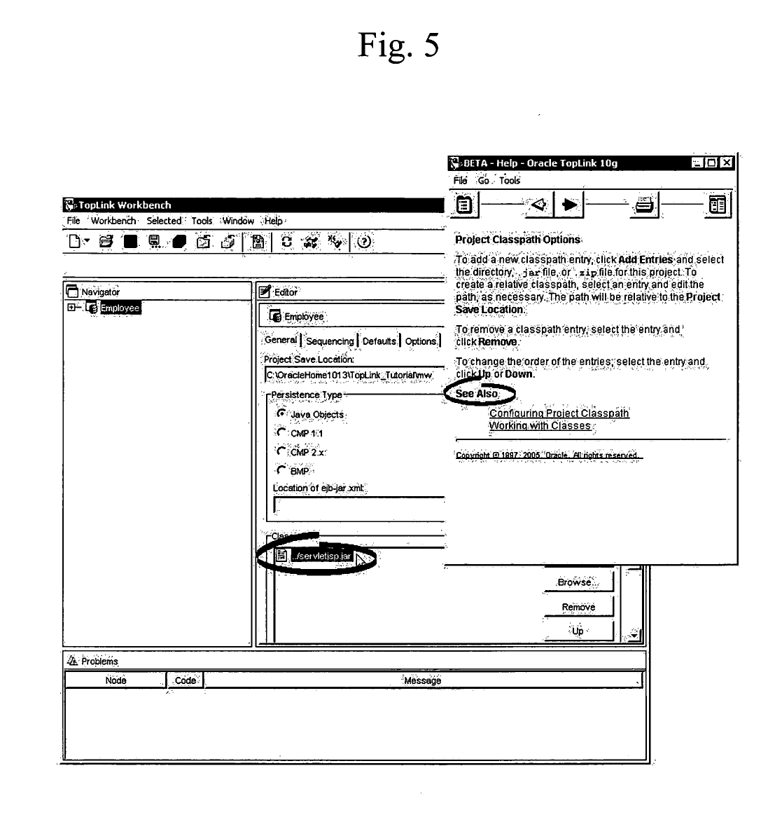

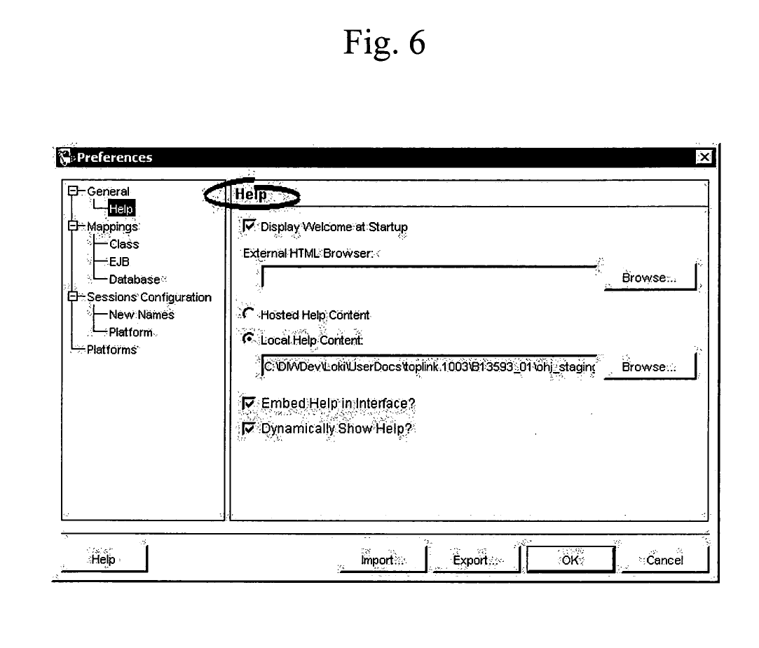

An exemplary block diagram of a computer system 400 is shown in FIG. 4. System 400 is typically a programmed general-purpose computer system, such as a personal computer, workstation, server system, and minicomputer or mainframe computer. System 400 includes one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which System 400 is implemented as a single multi-processor computer system, in which multiple processors 402A-402N share system resources, such as memory 408, input/output circuitry 404, and network adapter 406. However, the present invention also contemplates embodiments in which System 400 is implemented as a plurality of networked computer systems, which may be single-processor computer systems, multi-processor computer systems, or a mix thereof.

Input/output circuitry 404 provides the capability to input data to, or output data from, database/System 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces database/System 400 with Internet/intranet 410. Internet/intranet 410 may include one or more standard local area network (LAN) or wide area network (WAN), such as Ethernet, Token Ring, the Internet, or a private or proprietary LAN/WAN.

Memory 408 stores program instructions that are executed by, and data that are used and processed by, CPU 402 to perform the functions of system 400. Memory 408 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 408 varies depending upon the function that system 400 is programmed to perform. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 4, memory 408 includes user interface routines 412, processing routines 414 help routines 416, help pages 418, and operating system 420. User interface routines 412 provide functionality to the user interface operated by the user, such as outputting information and status to the user and accepting commands and information from the user. Processing routines 414 provide additional functionality to the software. Help routines 416 provide the dynamic help processing provided by the present invention. Help pages 418 include help content that is displayed to the user by help routines 416. Operating system 412 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for providing help information to a user of software comprising:
providing a user interface of the software;
determining an element or function of the software that the user likely intends to use;
identifying help information corresponding to the element or function of the software that the user likely intends to use; and
displaying the identified help information to the user.

2. The method of claim 1, wherein the identified help information is displayed to the user by:
displaying the help information in a portion of the user interface so that the help information does not obscure any other portion of the user interface.

3. The method of claim 2, wherein the help information is displayed in a pane of the user interface.

4. The method of claim 2, wherein the element or function of the software that the user likely intends to use is determined by:
identifying a focus of a selection of an element of the user interface by the user; and
determining an element or function of the software that the user likely intends to use based on the selection of an element of the user interface by the user.

5. The method of claim 4, wherein the help information corresponding to the element or function of the software that the user likely intends to use is identified by:
identifying a identifier corresponding to the likely user intent based on the selected interface element; and
obtaining the help page using the identified identifier.

6. The method of claim 5, wherein the identifier is a unique help topic identifier.

7. The method of claim 6, wherein the help page is obtained using the identified identifier by:
using the identifier to access a lookup table to identify the help page; and
obtaining the identified help page.

8. A system for providing help information to a user of software comprising:
a processor operable to execute computer program instructions;
a memory operable to store computer program instructions executable by the processor; and
computer program instructions stored in the memory and executable to perform the steps of:
providing a user interface of the software;
determining an element or function of the software that the user likely intends to use;
identifying help information corresponding to the element or function of the software that the user likely intends to use; and
displaying the identified help information to the user.

9. The system of claim 8, wherein the identified help information is displayed to the user by:
displaying the help information in a portion of the user interface so that the help information does not obscure any other portion of the user interface.

10. The system of claim 9, wherein the help information is displayed in a pane of the user interface.

11. The system of claim 9, wherein the element or function of the software that the user likely intends to use is determined by:
identifying a focus of a selection of an element of the user interface by the user; and
determining an element or function of the software that the user likely intends to use based on the selection of an element of the user interface by the user.

12. The system of claim 11, wherein the help information corresponding to the element or function of the software that the user likely intends to use is identified by:
identifying a identifier corresponding to the likely user intent based on the selected interface element; and
obtaining the help page using the identified identifier.

13. The system of claim 12, wherein the identifier is a unique help topic identifier.

14. The system of claim 13, wherein the help page is obtained using the identified identifier by:
using the identifier to access a lookup table to identify the help page; and
obtaining the identified help page.

15. A computer program product for providing help information to a user of software comprising:
a computer readable medium;
computer program instructions, recorded on the computer readable medium, executable by a processor, for performing the steps of
providing a user interface of the software;
determining an element or function of the software that the user likely intends to use;
identifying help information corresponding to the element or function of the software that the user likely intends to use; and
displaying the identified help information to the user.

16. The computer program product of claim 15, wherein the identified help information is displayed to the user by:
displaying the help information in a portion of the user interface so that the help information does not obscure any other portion of the user interface.

17. The computer program product of claim 14, wherein the help information is displayed in a pane of the user interface.

18. The computer program product of claim 14, wherein the element or function of the software that the user likely intends to use is determined by:
identifying a focus of a selection of an element of the user interface by the user; and
determining an element or function of the software that the user likely intends to use based on the selection of an element of the user interface by the user.

19. The computer program product of claim 18, wherein the help information corresponding to the element or function of the software that the user likely intends to use is identified by:
identifying a identifier corresponding to the likely user intent based on the selected interface element; and
obtaining the help page using the identified identifier.

20. The computer program product of claim 19, wherein the identifier is a unique help topic identifier.

21. The computer program product of claim 20, wherein the help page is obtained using the identified identifier by:
using the identifier to access a lookup table to identify the help page; and
obtaining the identified help page.
